(19) United States
(12) Patent Application Publication
(10) Pub. No.: US 2014/0205138 A1
(43) Pub. Date: Jul. 24, 2014

(54) DETECTING THE LOCATION OF A KEYBOARD ON A DESKTOP

(71) Applicant: MICROSOFT CORPORATION, Redmond, WA (US)

(72) Inventors: Peter John Ansell, Cambridge (GB); Jamie Daniel Joseph Shotton, Cambridge (GB); Christopher Jozef O'Prey, Bury St Edmunds Suffolk (GB)

(73) Assignee: MICROSOFT CORPORATION, Redmond, WA (US)

(21) Appl. No.: 13/745,041

(22) Filed: Jan. 18, 2013

(51) Int. Cl. G06K 9/00

(52) U.S. Cl. CPC G06K 9/00201
USPC 382/103

(57) ABSTRACT

Methods and systems for detecting the location of a keyboard on a desktop. The method includes receiving an image of the desktop with the keyboard situated thereon and analyzing the image of the desktop to identify an area of the image corresponding to the keyboard. In one example, the image of the desktop is a depth image and analyzing the image of the desktop includes identifying an image element of the depth image that forms part of the keyboard, identifying first and second corners of the keyboard from the identified image element and determining the area of the image corresponding to the keyboard based on the first and second corners.

### BACKGROUND

There are many application domains where it is useful to know the geographical layout of a desktop or workspace. For example, remote workspace sharing, video conferencing, augmented reality, computer gaming, human-computer interaction and others. Accordingly, it is beneficial to know the location of a user's keyboard on the desktop or workspace. However, the fact there are many types of keyboards with varying shapes and colors makes it difficult to accurately detect the location of a keyboard on a desktop or workspace.

The embodiments described below are not limited to implementations which solve any or all of the disadvantages of known computing systems which detect the location of objects.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Described herein are methods and systems for detecting the location of a keyboard on a desktop. The methods include receiving an image of the desktop with the keyboard situated thereon and analyzing the image of the desktop to identify an area of the image corresponding to the keyboard. In an example embodiment, the image of the desktop is a depth image and analyzing the image of the desktop includes identifying an image element of the depth image that forms part of the keyboard, identifying first and second corners of the keyboard from the identified image element, and determining the area of the image corresponding to the keyboard based on the first and second corners.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a system for detecting the location of a keyboard on a desktop;

FIG. 2 is a schematic diagram of an example capture device of FIG. 1;

FIG. 3 is a flow diagram of a method for detecting the location of a keyboard on a desktop in accordance with a first embodiment;

FIG. 4A is a schematic diagram of a depth image used in the method of FIG. 3;

FIG. 4B is a chart of depth information for a vertical slice of the depth image of FIG. 4A;

FIG. 5 is a flow diagram of a method for identifying the corner of an object;

FIG. 6 is a flow diagram of a method for detecting the location of a keyboard on a desktop in accordance with a second embodiment;

FIG. 7 is a flow diagram of a method for detecting the location of a keyboard on a desktop in accordance with a third embodiment;

FIG. 8 is a flow diagram of a method for detecting the location of a keyboard on a desktop in accordance with a fourth embodiment;

FIG. 9 is a flow diagram of a method for detecting the location of a keyboard on a desktop in accordance with a fifth embodiment;

FIG. 10A is a schematic diagram of a depth image used in the method of FIG. 9;

FIG. 10B is a chart of depth information for a vertical slice of the depth image of FIG. 10A; and

FIG. 11 illustrates an exemplary computing-based device in which embodiments of the system and/or methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a keyboard location system using depth images, the system described is provided as an example and not a limitation. As those skilled in the art will appreciate, the present examples are suitable for application in a variety of different types of keyboard location systems using color images, silhouette images, or other types of images.

Embodiments described herein relate to methods and systems for identifying the location of a keyboard on a desktop or workspace.

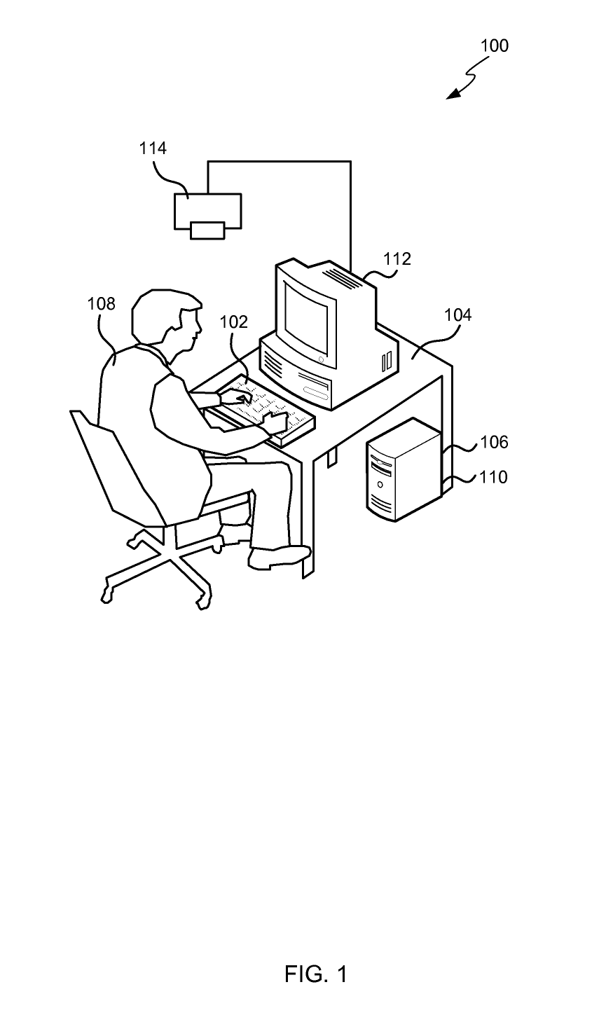

Reference is first made to FIG. 1, which illustrates an example system 100 for identifying or detecting the location of a keyboard 102 on a desktop or workspace 104. The keyboard 102 is typically in communication (e.g. via a wired or wireless connection) with a computing-based device 106 allowing a user 108 to control the computing-based device 106 via the keyboard 102.

The computing-based device 106 shown in FIG. 1 is a traditional desktop computer with a separate processor component 110 and display screen 112; however, the methods and systems described herein may equally be applied to other types of computing-based devices 106, such as computing-based devices 106 wherein the processor component 110 and display screen 112 are integrated such as in a laptop computer or a tablet computer.

The system 100 further comprises a capture device 114 for capturing images of the desktop or workspace 104 with the keyboard 102 situated thereon. In FIG. 1, the capture device 114 is mounted above and pointing downward at the user's desktop or workspace 104. However, in other examples, the capture device 114 may be mounted in or on the keyboard 102; or another suitable object in the environment.

In operation, the location of the keyboard 102 on the desktop or workspace 104 can be identified and tracked using image(s) captured by the capture device 114. This information may be then be used as input to other applications. For example, some applications may allow a user to control the computing-based device 106 through hand gestures performed on or above the keyboard 102.

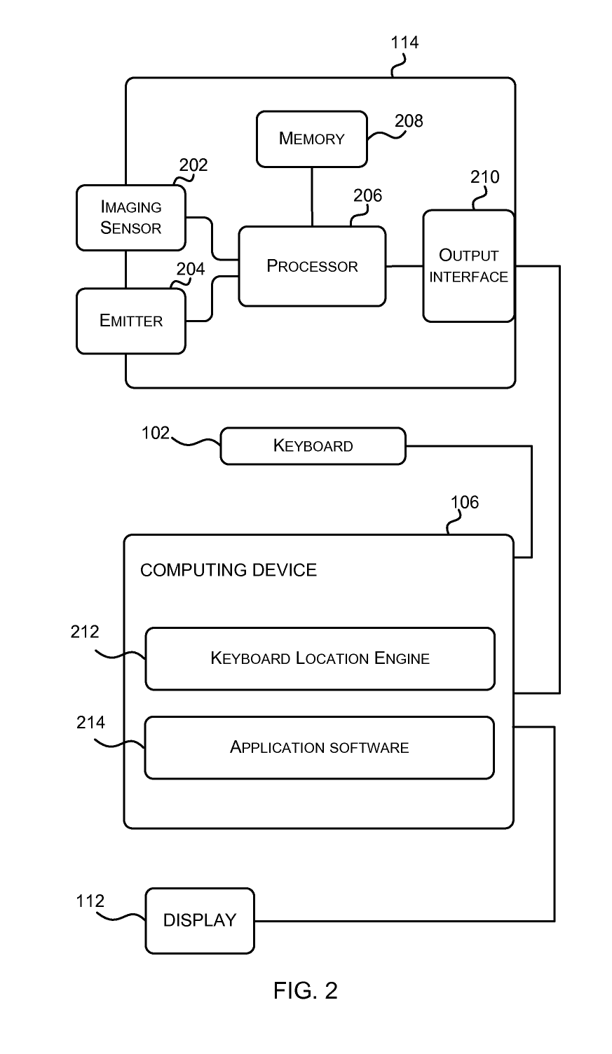

Reference is now made to FIG. 2, which illustrates a schematic diagram of a capture device 114 that may be used in the system 100 of FIG. 1. The capture device 114 comprises at least one imaging sensor 202 for capturing images of the desktop or workspace 104. The imaging sensor 202 may be a depth camera arranged to capture depth information of a scene. The depth information may be in the form of a depth image that includes depth values, i.e. a value associated with each image element (e.g. pixel) of the depth image that is related to the distance between the depth camera and an item or object located at that image element.

The depth information can be obtained using any suitable technique including, for example, time-of-flight, structured light, stereo image, or the like.

The captured depth image may include a two dimensional (2-D) area of the captured scene where each image element in the 2-D area represents a depth value such as length or distance of an object in the captured scene from the imaging sensor 202.

In some cases, the imaging sensor 202 may be in the form of two or more physically separated cameras that view the scene from different angles, such that visual stereo data is obtained that can be resolved to generate depth information.

The capture device 114 may also comprise an emitter 204 arranged to illuminate the scene in such a manner that depth information can be ascertained by the imaging sensor 202.

The capture device 114 may also comprise at least one processor 206, which is in communication with the imaging sensor 202 (e.g. depth camera) and the emitter 204 (if present). The processor 206 may be a general purpose microprocessor or a specialized signal/image processor. The processor 206 is arranged to execute instructions to control the imaging sensor 202 and emitter 204 (if present) to capture images (e.g. depth images). The processor 206 may optionally be arranged to perform processing on these images and signals, as outlined in more detail below.

The capture device 114 may also include memory 208 arranged to store the instructions for execution by the processor 206, images or frames captured by the imaging sensor 202, or any suitable information, images or the like. In some examples, the memory 208 can include random access memory (RAM), read only memory (ROM), cache, Flash memory, a hard disk, or any other suitable storage component. The memory 208 can be a separate component in communication with the processor 206 or integrated into the processor 206.

The capture device 114 may also include an output interface 210 in communication with the processor 206. The output interface 210 is arranged to provide data to the computing-based device 106 via a communication link. The communication link can be, for example, a wired connection (e.g. USB™, Firewire™, Ethernet™ or similar) and/or a wireless connection (e.g. WiFi™, Bluetooth™ or similar). In other examples, the output interface 210 can interface with one or more communication networks (e.g. the Internet) and provide data to the computing-based device 106 via these networks.

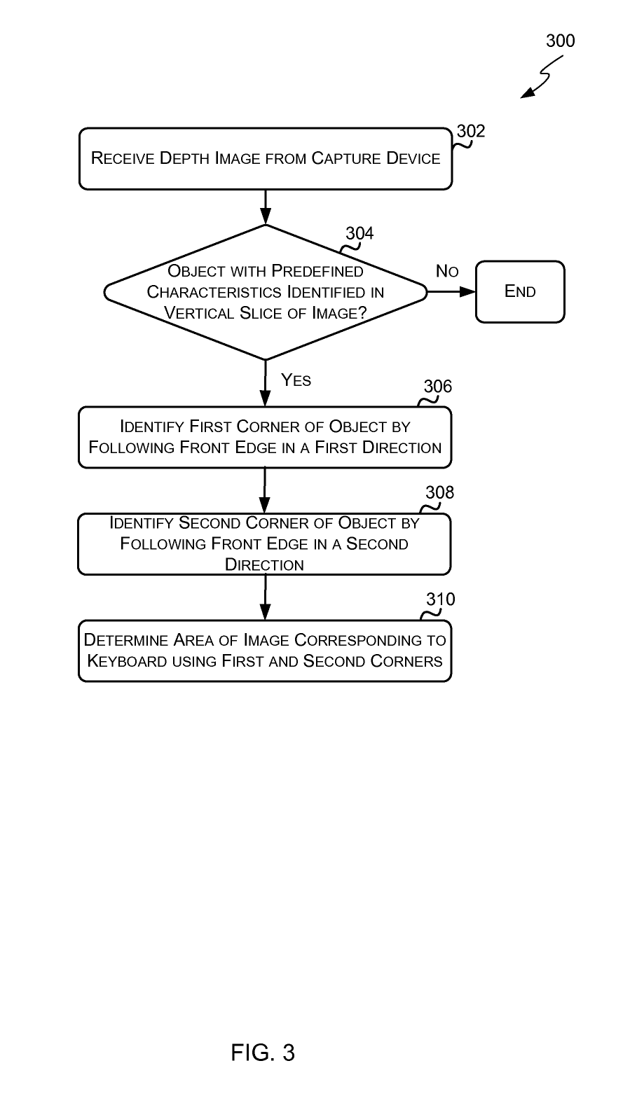

The computing-based device 106 may execute a number of functions related to the detection of the location of the keyboard 102 on the desktop or workspace 104, such as a keyboard location engine 212. For example, the keyboard location engine 212 may be configured to execute one of the methods described in relation to FIGS. 3 to 10 to detect the location of the keyboard 102 with respect to the desktop or workspace 104.

Application software 214 may also be executed on the computing-based device 106 and controlled using the output received from the keyboard location engine 212. For example, the application software 214 may be software that is configured to recognize hand gestures made by the user in reference to the keyboard 102 and to control the computing-based device 106 accordingly.

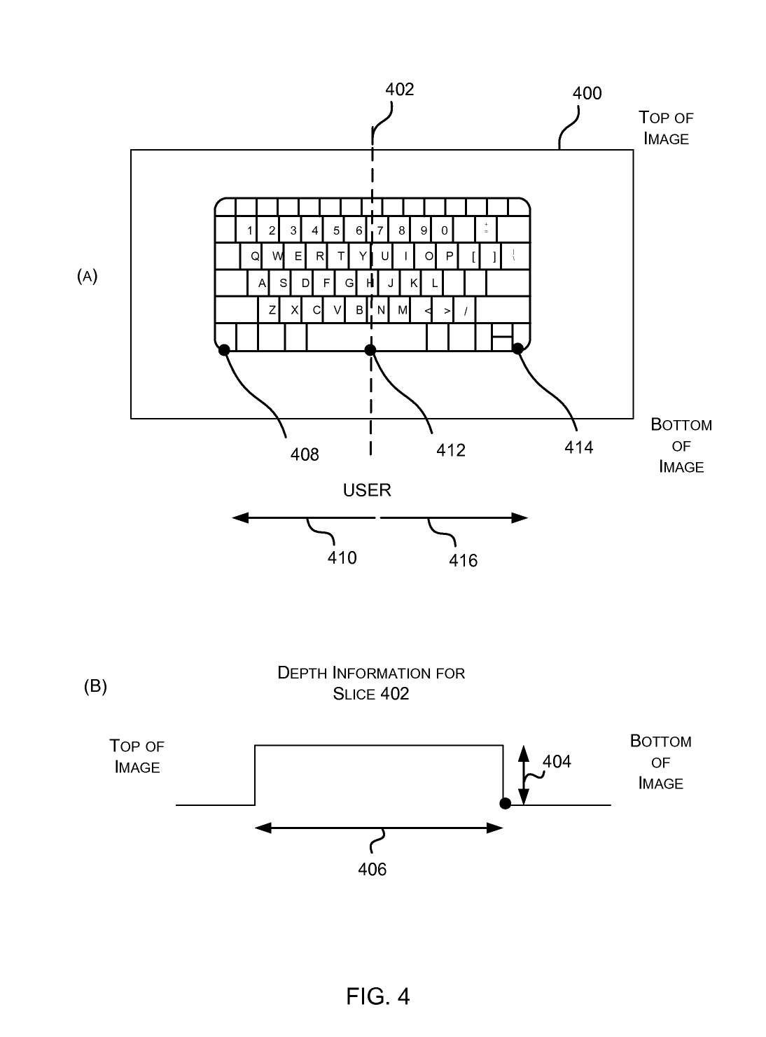

Reference is now made to FIGS. 3 and 4 which illustrate a method 300 for detecting the location of the keyboard 102 with respect to the desktop or workspace 104 in accordance with a first embodiment. Specifically, FIG. 3 is a flow diagram of the method 300 and FIG. 4 is a set of schematics illustrating how an image 400 from the capture device 114 may be processed in accordance with method 300. In this method 300 a depth image is used to identify a surface (e.g. front edge) of the keyboard. The identified surface is then used to estimate the area of the image corresponding to the keyboard.

At block 302, a depth image 400 of the workspace or desktop 104 is received from the capture device 114. As described above a depth image is an image that comprises a depth value associated with each image element (e.g. pixel) of the image. The depth value represents the distance between the camera and the object depicted by the image element. Once the depth image 400 is received, the method 300 proceeds to block 304.

At block 304, a vertical slice 402 of the depth image 400 is analyzed to determine if the desktop or workspace comprises an object with a depth 404 within a predetermined range for a distance 406 within a predetermined range. For example, the vertical slice 402 is analyzed to find a surface depicted in the image where the surface extends substantially parallel to the camera for at least a specified length, and where the surface is within a specified depth range from the camera.

In some examples the depth is in reference to the plane of the desktop or workspace. The plane of the desktop may be determined using any suitable method. For example, the plane of the desktop may be determined by a random sample consensus (RANSAC) algorithm. A RANSC algorithm typically comprises selecting a number of image elements at random, fitting a plane to the image elements and comparing the image elements to the plane. This process is iteratively repeated and the plane with the largest number of image elements on the plane is selected.

In some examples, the RANSAC algorithm may be implemented by selecting a set of candidate image elements (e.g. pixels) that are likely to include a high proportion of image elements that form part of the desk or workspace. The set of candidate image elements may be selected to be image elements at the edge of the image since the centre of the image is likely to be occupied by the keyboard. A plane is then fitted to the current set of candidate image elements. If this plane fits all of the set of candidate images very closely, then the plane of the desktop is determined to be this plane. If, however, the plane is a poor fit for the set of candidate image elements, the candidate image elements that appear above the plane are presumed to be objects placed onto the desktop and are removed from the set of candidate image elements. A new plane is generated and compared to the remaining candidate image elements. The process of removing image elements and generating and fitting a new plane is iteratively repeated until the generated plane is a good fit for the candidate image elements. A plane may be deemed to be a good fit for the candidate image elements when a predefined percentage of the candidate image elements are within a predetermined distance of the plane.

Once the plane of the desktop has been determined, the vertical slice 402 is analyzed to identify any object that is a certain height above the desktop and is a certain width. Any object that is not high enough from the desktop or is too high from the desktop may be ignored. Similarly, any object that is has too small a width or too large a width may be ignored.

The depth and distance ranges may be established from the parameters of a set of known or common keyboards. For example, the depth and distance ranges may be established from the depth and width of a predetermined number (e.g. 20 or 30) of known keyboard models. In particular, the depth range may be set to cover the minimum depth of the known keyboard models to the maximum depth of the known keyboard models. Similarly the length range may be set to cover the minimum width of the known keyboard models to the maximum width of the known keyboard models. In some examples, the depth and distance ranges may be fine-tuned based on information identifying the keyboard. In particular, the system may be able obtain information identifying the keyboard and use this information to set the depth and distance ranges. For example, keyboards that are connected to the computing-based device 106 via USB (Universal Serial Bus) typically provide the computing-based device 106 with information about the manufacturer and model of the keyboard.

In some examples, the vertical slice 402 is selected to be a vertical line extending along the centre line from the user to increase the likelihood of the slice 402 comprising image elements that relate to the keyboard. Specifically, because users tend to place the keyboard centrally in front of them a slice of the image directly in front of the user is likely to comprise image elements that relate to the keyboard.

If it is determined that the image contains an object that meets the predetermined depth and distance criteria the method 300 proceeds to block 306. If, however, it is determined that the image does not contain an object that meets the predetermined depth and width criteria then the method 300 ends.

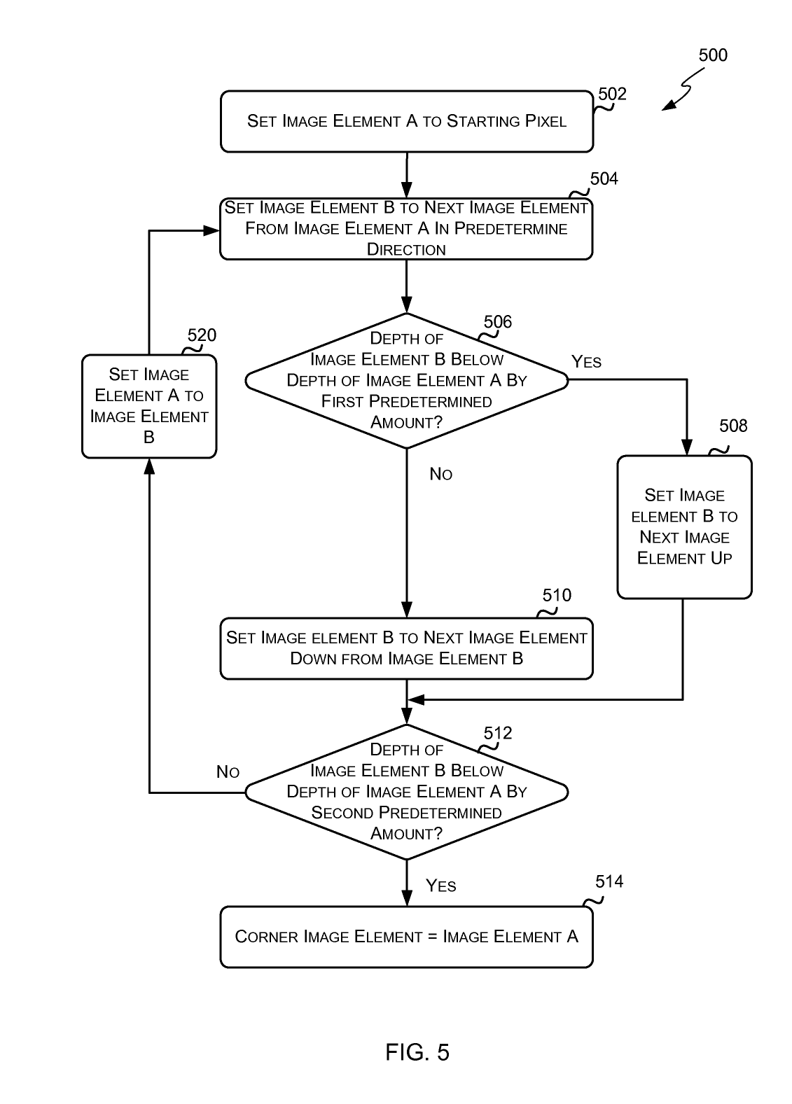

At block 306, a first corner 408 of the object is located from the depth image 400. In some examples, the first corner 408 is located by identifying the front edge of the object and traversing the front edge in a first direction 410 until a corner is reached. An example method for locating the corner of an object using a depth image by traversing the front edge of the object is described in reference to FIG. 5. Once a first corner 408 has been identified the method 300 proceeds to block 308.

At block 308, a second corner 414 of the object is located from the depth image 400. In some examples, the second corner 414 is located by traversing the front edge in a second direction 416 until a corner is reached. The second direction 416 is in the opposite direction to the direction 410 used in block 306.

In some examples, the traversal is started at the image element 412 in the vertical slice 402 that is closest to the user and part of the object since it is presumed that this image element 412 forms part of the front edge of the keyboard. The second corner 414 may be identified as the last image element that forms part of the front edge extending from the starting image element 412 in the particular horizontal direction (e.g. right) 416. Once the second corner 414 has been identified the method 300 proceeds to block 310.

At block 310, the area of the image corresponding to the keyboard is determined using the first and second corners 408 and 414 identified in blocks 306 and 308. Once the area of the image corresponding to the keyboard is determined the method 300 ends.

In some examples, the method 300 may be repeated periodically (e.g. every 10 seconds) to determine if the keyboard 102 has been moved with respect to the desktop or workspace 104.

In some examples, the method 300 may be implemented with a color image instead of a depth image. In these examples, instead of analyzing a vertical slice of the image to identify an object that has a depth within a predetermined range over a distance within a predetermined range, a vertical slice of the image is analyzed to identify an object that has a color value within a predetermine range over a distance within a predetermined range. The remainder of the method 300 remains the same with the exception that instead of using the depth values associated with each image element (e.g. pixel) to determine whether an image element is part of the object the color values associated with each image element (e.g. pixel) are used to determine whether an image element is part of the object and thus part of the front edge.

Reference is now made to FIG. 5 which illustrates a flow diagram of a method 500 for identifying the corner of an object (e.g. keyboard) using a depth image by identifying and traversing the front edge of the object. The method 500 may be used in block 306 and/or block 308 of method 300 to identify the first corner 408 and second corner 414 respectively.

At block 502, image element A is set to be the starting image element. In some examples, the starting image element may be the image element 412 in the vertical slice 402 that is closest to the user, yet still part of the object. Once image element A has been set to the starting image element, the method 500 proceeds to block 504.

At block 504, image element B is set to be the next image element in the predetermined direction (e.g. direction 410 or direction 416). Once image element B has been set to the next image element in the predetermined direction, the method 500 proceeds to block 506.

At block 506, the depths associated with image elements A and B are compared to determine if the depth associated with image element B is below the depth associated with image element A by a first predetermined amount. If the depth of image element B is below the depth of image element A by a first predetermined amount then it is likely that image element B lies on the desktop surface and the method 500 proceeds to block 508. If, however, the depth of image element B is not below the depth of image element A by the predetermined amount then it is likely that image element B forms part of the keyboard and the method 500 proceeds to block 510.

At block 508, element B is set to the next image element up from image element B. The method 500 then proceeds to block 512.

At block 510, image element B is set to the next image element down from image element B. The method 500 then proceeds to block 512.

At block 512, the depths associated with image elements A and B are compared to determine if the depth associated with image element B is below the depth associated with image element A by a first predetermined amount. If the depth of image element B is below the depth of image element A by the second predetermined amount then it is likely that image element A is the corner image element and the method 500 proceeds to block 514. If, however, the depth of image element B is not below the depth of image element A by the second predetermined amount then it is likely that image element A is not the corner image element and the method 500 proceeds to block 516.

At block 514, image element A is deemed to be the corner image element.

At block 516 image element A is set to image element B and then the method repeats at block 504.

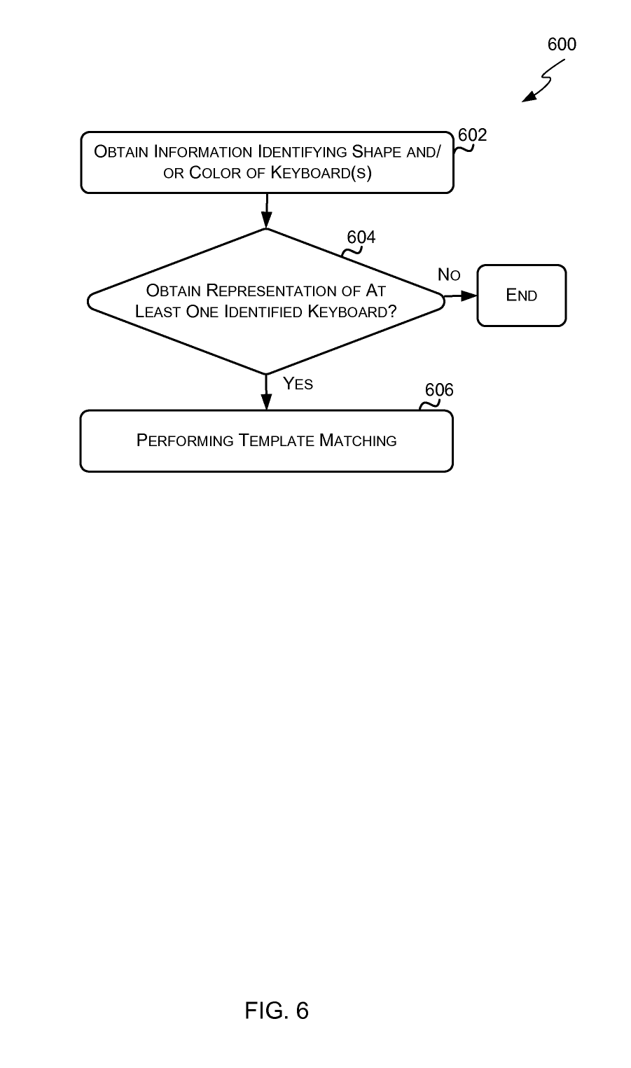

Reference is now made to FIG. 6 which illustrates a flow diagram of a method 600 for identifying or detecting the location of the keyboard 102 with respect to the desktop or workspace 104 in accordance with a second embodiment. In this method 600, information identifying the specific type of keyboard is used to obtain a representation of the keyboard. The representation of the keyboard is then compared to the image received from the capture device 114 to identify the location of the keyboard 102 with respect to the desktop or workspace 104.

At block 602, information identifying the shape and/or color of the keyboard is obtained. In some examples, information identifying the shape and/or color of the keyboard is obtained automatically from the computing-based device's 106 device list. In particular, many devices that may connect to or be in communication with a computing-based device (e.g. mouse and keyboard) are configured to provide details about the device to the computing-based device 106. This information is typically stored in a “device list”. For example, devices that are connected to the computing-based device 106 via USB (Universal Serial Bus) typically provide the computing-based device 106 with information about the type of device (e.g. keyboard), manufacturer and model.

For each keyboard in the device list, the device list information is analyzed to identify information that can be used to identify the shape and color of the keyboard. Information that may be used to identify the shape and color of the keyboard includes, but is not limited to, the manufacturer and model number of the keyboard.

In other examples, the information identifying the shape and color of the keyboard is obtained directly from the user. For example, the user may manually enter the make and model number of the keyboard. Once the information identifying the shape and color of the keyboard is obtained the method 600 proceeds to block 604.

At block 604, an attempt is made to obtain a representation of each keyboard identified in block 602 using the information identifying the shape and color of the keyboard. The representation of the keyboard may be an image of the keyboard. In some examples, a database of keyboard representations is searched using the information identifying the shape and color of the keyboard to determine if the database comprises a representation for each identified keyboard. In other examples, a web image search is conducted using the information identifying the shape and color of the keyboard. If a representation for at least one identified keyboard is obtained then the method 600 proceeds to block 606. If, however, a representation of at least one identified keyboard is not obtained then the method 600 ends.

At block 606, template matching is performed using the image of the desktop received from the capture device 114 and each keyboard representation located in block 604 to determine the location of the keyboard with respect to the desktop. In particular, each keyboard representation located in block 604 is compared against the desktop image received from the capture device 114 to determine a match. Any known template matching technique, such as standard vision template matching, may be used to determine the location of the keyboard.

The method 600 of FIG. 6 may be used with any type of image including a depth image, a color image, a silhouette image, and edge image, a disparity map from a stereo image pair, and a sequence of images. The image may be two dimensional (2-D), three dimensional (3-D) or higher dimensional.

In some examples, a rough estimate of the position of the keyboard may be obtained using the method described in reference to FIGS. 3 to 5 and then the method 600 described in reference to FIG. 6 may be used to further refine the position of the keyboard. For example, an iterated closed point matching may be used to align the representation of the keyboard with the desktop image received from the capture device 114.

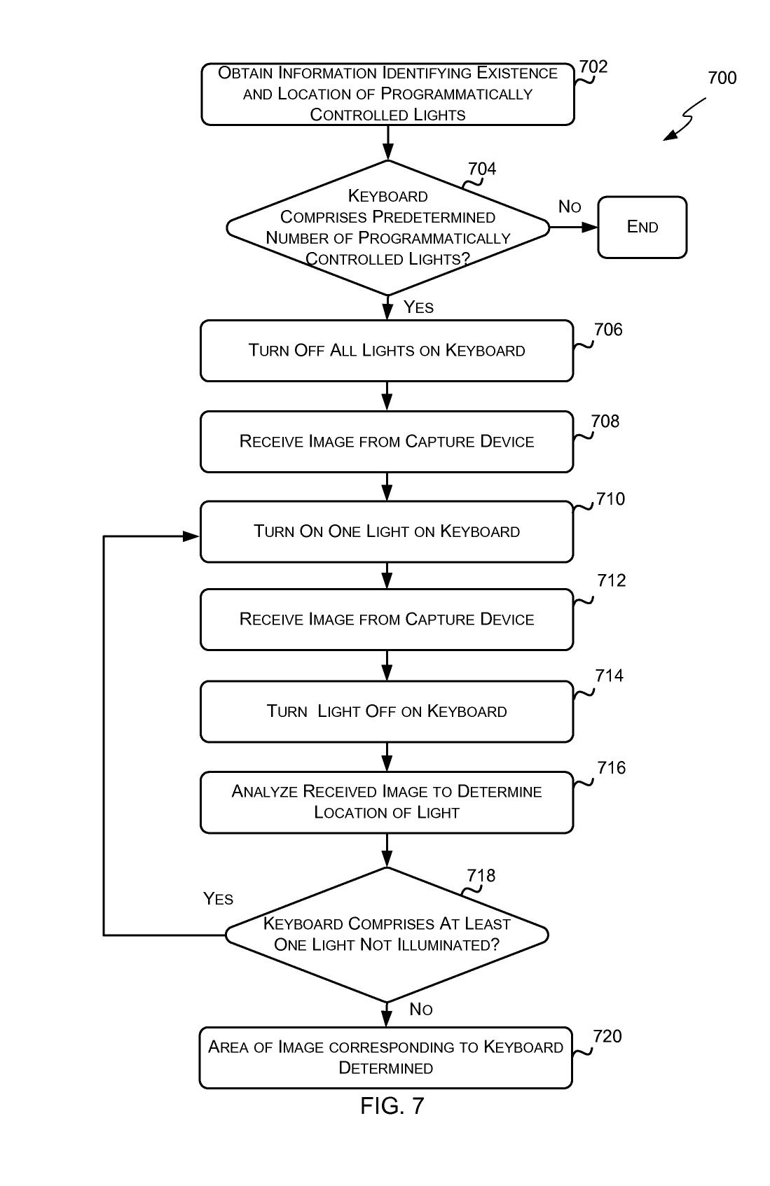

Reference is now made to FIG. 7 which illustrates a flow diagram of a method 700 for identifying or detecting the location of a keyboard 102 with respect to a desktop or workspace 104 in accordance with a third embodiment. Many keyboards are equipped with programmatically controlled light sources (e.g. LEDs (light emitting diodes)) that indicate various states of the keyboard (e.g. caps, num-lock and scroll-lock). In this method 700, information identifying the specific type of keyboard is used to determine the existence and location of any programmatically controlled light sources on the keyboard. Each light source is turned on one at a time and an image is received from the capture device 114 with the keyboard in this state. These images are analyzed to determine the location of the light sources in the desktop. The location of the keyboard with respect to the desktop is then determined on the basis of the depiction of the light source(s) in the image and based on the where the light sources are on the particular type of keyboard.

At block 702 information identifying the existence and location of any programmatically controlled light sources on the keyboard is obtained.

In some examples, the information identifying the existence and location of any programmatically controlled light sources on the keyboard is automatically obtained from the computing-based device's 106 device list. As described above with respect to method 600, many devices that connect to a computing-based device (e.g. mouse and keyboard) are configured to provide information about the device to the computing-based device 106 such the type of device, manufacturer and model. This information is typically stored in what is referred to as the “device list”.

If there is at least one keyboard in the device list, information identifying the existence and location of any programmatically controlled light sources on the keyboard is obtained from the device list (if available). Information identifying the existence and location of any programmatically controlled light sources on the keyboard may include, but is not limited to, the manufacturer and model number of the keyboard.

In other examples, the information identifying the existence and location of any programmatically controlled light sources on the keyboard is manually provided by the user. For example, the user may manually provide the manufacturer and model number of the keyboard.

Once the information identifying the existence and location of any programmatically controlled light sources on the keyboard is obtained, the method 700 proceeds to block 704.

At block 704, the information identifying the existence and location of any programmatically controlled light sources (e.g. manufacturer and model) is used to determine whether the keyboard has any programmatically controlled light sources. In some examples, determining whether the keyboard has any programmatically controlled light sources may comprise using the information identifying the existence and location of any programmatically controlled light sources (e.g. manufacturer and model) to locate information on the keyboard in a manufacturer's database or a local database. In other examples, determining whether the keyboard has any programmatically controlled light sources may comprise using the information identifying the existence and location of any programmatically controlled light sources (e.g. manufacturer and model) to conduct a web search.

If it is determined that the keyboard has a predetermined number of programmatically controlled light sources, the method 700 proceeds to block 706. If, however, it is determined that the keyboard does not have the predetermined number of programmatically controlled light sources, then the method 700 ends. The predetermined number of programmatically controlled light sources may depend on the type of keyboard and the shape of the light sources. For example, in some cases, a single light source may be sufficient for determining the location of the keyboard (e.g. when the keyboard has a specially-shaped (e.g. rectangular-shaped) light source). However, in many other cases two light sources are required to determine the location of the keyboard.

At block 706, the computing-based device 106 sends a signal to the keyboard to turn off all of the identified light sources (e.g. the programmatically controlled light sources). Once all of the light sources have been turned off, the method 700 proceeds to block 708.

At block 708, an image of the desktop or workspace with all the programmatically controlled light sources off is received from the capture device 114 and saved. Once the image has been received, the method 700 proceeds to block 710.

At block 710, the computing-based device 106 sends a signal to the keyboard to turn on a programmatically controlled light source that has not already been turned on in block 710. Once the light source has been turned-on or illuminated the method 700 proceeds to block 712.

At block 712, an image of the desktop or workspace with this single programmatically controlled light source on is received from the capture device 114 and saved. Once the image has been received, the method 700 proceeds to block 714.

At block 714, the computing-based device 106 sends a signal to the keyboard to turn off or de-illuminate the light source turned-on at block 710. Once the light source has been turned-off or de-illuminated the method 700 proceeds to block 716.

At block 716, the image received in block 712 is analyzed to determine the location of the light source in the image. For example, the location of the light source may be identified as the area of the image that shows the most increased illumination with respect to the image received in block 708 (e.g. when all of the light sources are turned off). Once the image has been analyzed, the method proceeds to block 718.

At block 718 it is determined whether the keyboard comprises any additional programmatically controlled light sources that have not been turned-on or illuminated in block 710. If it is determined that the keyboard comprises at least one programmatically controlled light source that has not been turned-on or illuminated then the method 700 proceeds back to block 710. If, however, all of the programmatically controlled light sources on the keyboard have been turned-on in block 710 then the method 700 proceeds to block 720.

At block 720, the area of the image received from the capture device 114 corresponding to the keyboard is determined based on the location of the light sources in the image identified in block 716 and the location of the light sources with respect to a keyboard of the particular type. In some examples, standard mapping algorithms may be used to map the location of the light sources for the particular type of keyboard thus providing the geometry of the keyboard. For example, if it is known that the keyboard has a Caps Lock LED in the Caps Lock key and a Scroll Lock LED in the top right corner of the keyboard, the geometry of the keyboard and thus its location can be obtained.

The method 700 of FIG. 7 may be used with any type of image which captures information about the location of the light source sources, such as a color image.

While method 700 describes individually turning each light source on and off, method 700 may be varied to use any on/off pattern of the light sources that allows the identities and location of the light sources to be unique identified. For example, instead of individually turning on and off each light source, the light sources may be turned on and off in a unique binary code. This may be more time efficient than turning each light source on and off individually.

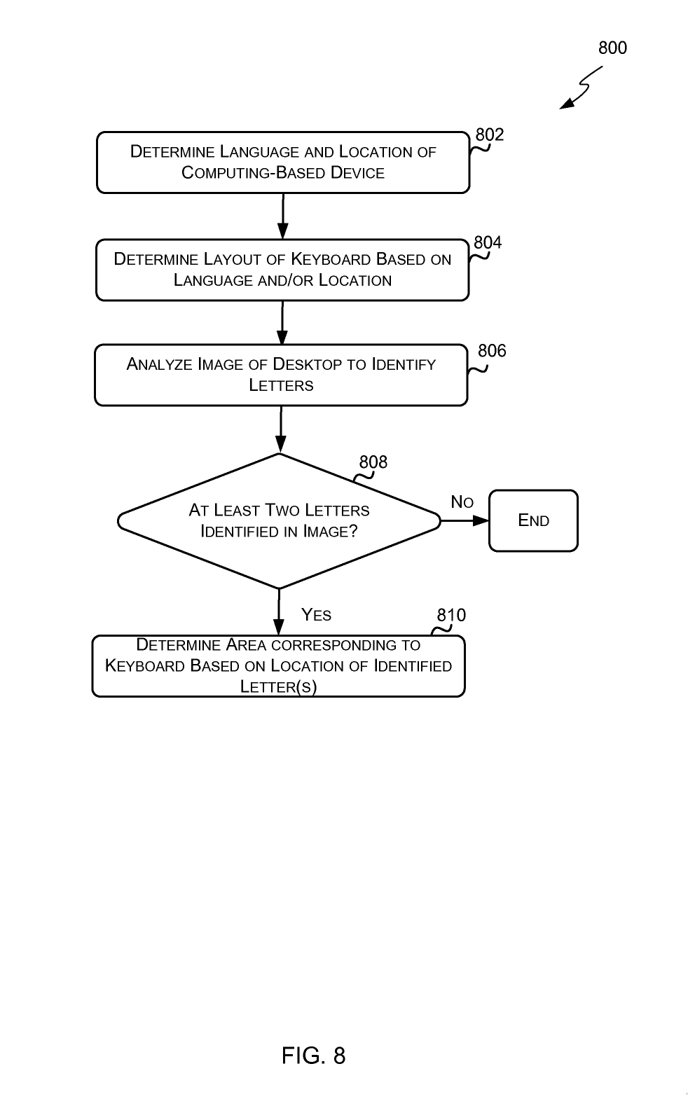

Reference is now made to FIG. 8 which illustrates a flow diagram of method 800 for identifying or detecting the location of the keyboard 102 with respect to a desktop or workspace 104 in accordance with a fourth embodiment. In this method 800 the location of the keyboard is identified by locating letter shapes in the image of the desktop or workspace received from the capture device 114. For example, on US keyboards the standard QWERTY layout of letters can be located.

At block 802, the language and/or location used by the computing-based device 106 is determined, such as Chinese or US English. In some examples the language and/or location is determined from the computing-based device's 106 configuration settings. In other examples, the language and/or location is manually input by the user. Once the language and/or location have been determined, the method 800 proceeds to block 804.

At block 804, the language and/or location information determined in block 802 is used to determine the layout of the keys on the keyboard. For example, U.S. English keyboards typically use the standard QWERTY layout of letters, whereas Austrian and German keyboards typically use the standard QWERTZ layout of letters. Once the keyboard layout has been determined, the method proceeds to block 806.

At block 806, the image of the desktop received from capture device 114 is analyzed to locate one or more of the letters on the keyboard layout determined in block 804. Any known technique, such as template matching or optical character recognition may be used to locate letters in the image.

At block 808, it is determined whether any relevant letters are located in the image. If at least two relevant letters are located in the image then the method proceeds to block 810. If, however, less than two relevant letters were located in the image then the method 800 ends.

At block 810, the location of the located letters and the layout of the keys on the keyboard are used to determine the area of the image corresponding to the keyboard.

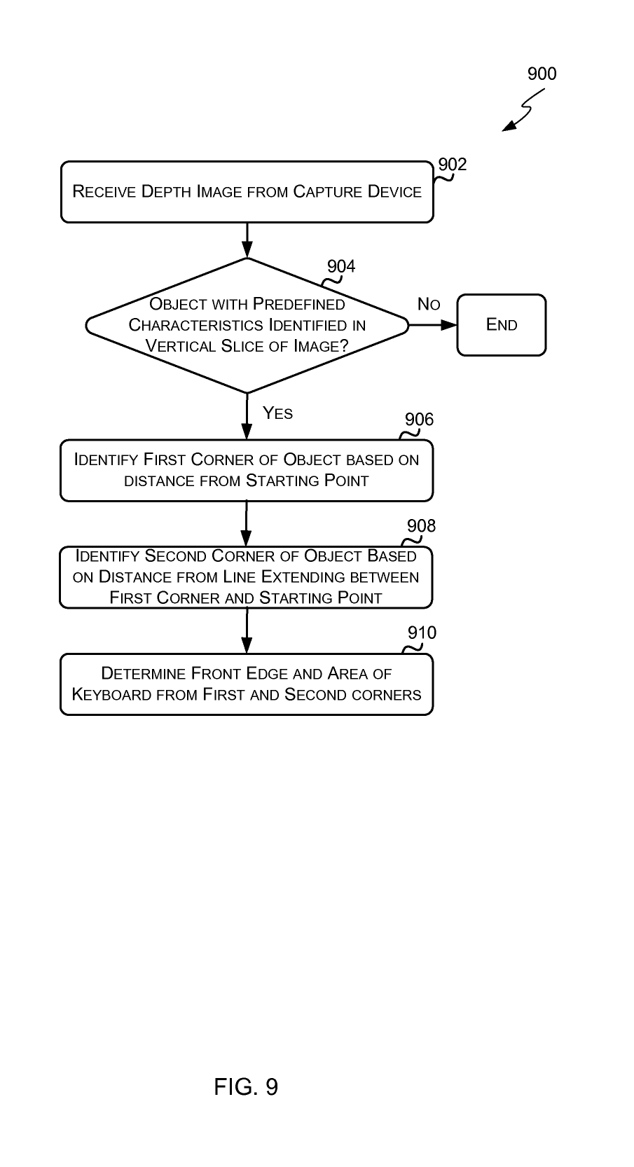

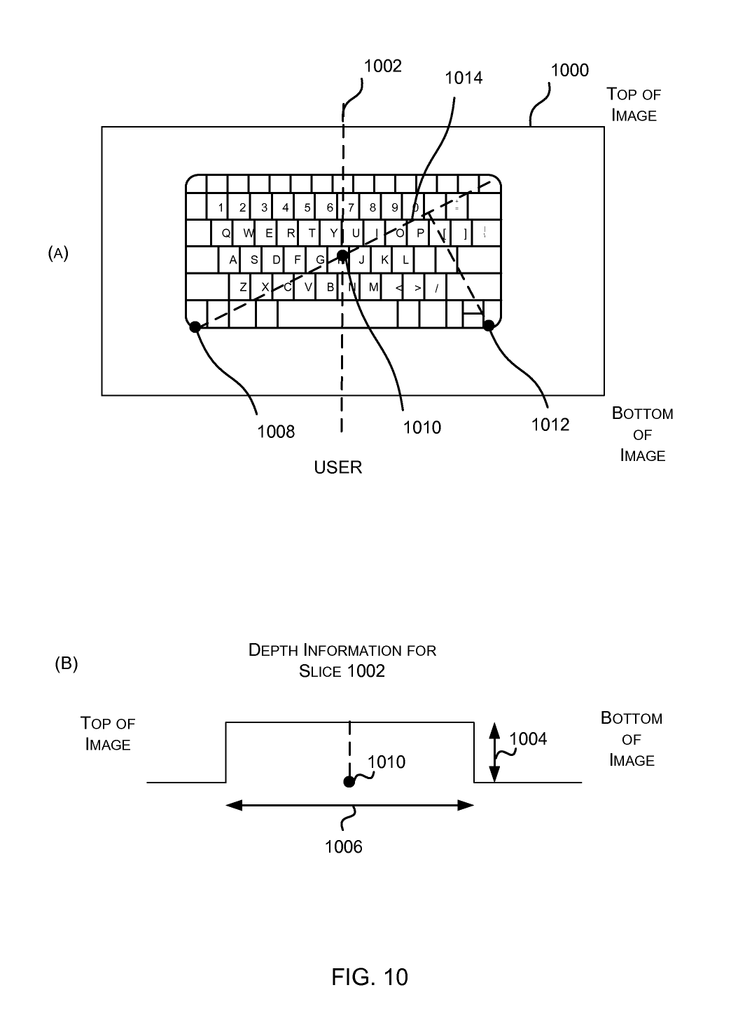

Reference is now made to FIGS. 9 and 10 which illustrate a method 900 for identifying or detecting the location of the keyboard 102 with respect to the desktop or workspace 104 in accordance with a fifth embodiment. Specifically, FIG. 9 illustrates a flow diagram of the method 900 and FIG. 10 is a set of schematics illustrating how the images received from the capture device 114 may be processed in method 900. In this method 900 a depth image is used to identify the front corners of the keyboard.

At block 902, a depth image 1000 of the workspace or desktop is received from the capture device 114. Once the depth image 1000 is received, the method 900 proceeds to block 904.

At block 904, a vertical slice 1002 of the depth image 1000 is analyzed to determine if the image contains an object with a depth 1004 within a predetermined range for a distance 1006 within a predetermined range.

In some examples the depth is in reference to the plane of the desktop. The plane of the desktop may be determined using any suitable method as described above in reference to method 300.

Once the plane of the desktop has been determined, the vertical slice 1002 is analyzed to identify any object that is a certain height above the desktop and is a certain width. Any object that is not high enough from the desktop or is too high from the desktop may be ignored. Similarly, any object that is has too small a width or too large a width may be ignored.

The depth and distance ranges may be established from the parameters of a set of known or common keyboards. For example, the depth and distance ranges may be established from the depth and width of a predetermined number (e.g. 20 or 30) of known keyboard models. In particular, the depth range may be set to cover the minimum depth of the known keyboard models to the maximum depth of the known keyboard models. Similarly the length range may be set to cover the minimum width of the known keyboard models to the maximum width of the known keyboard models. In some examples, the depth and distance ranges may be fine-tuned based on information identifying the keyboard. In particular, the system may be able obtain information identifying the keyboard and use this information to set the depth and distance ranges. For example, keyboards that are connected to the computing-based device 106 via USB (Universal Serial Bus) typically provide the computing-based device 106 with information about the manufacturer and model of the keyboard.

In some examples, the vertical slice 1002 is selected to be the vertical slice corresponding to the vertical line extending along the centre line from the user to increase the likelihood of the slice 1002 comprises image elements that relate to the keyboard. Specifically, because users tend to place the keyboard centrally in front of them a slice of the image directly in front of the users is likely to comprise image elements that relate to the keyboard. For example, an area of an image corresponding to a keyboard may be determined on the basis that image elements depicting the keyboard are likely to extend across the centre of the image.

If it is determined that the image contains an object with the predetermined depth and width criteria then the method 900 proceeds to block 906. If, however, it is determined that the image does not contain an object that meets the predetermined depth and width criteria then the method 900 ends.

At block 906, the first front corner 1008 of the keyboard is identified from the depth image 1000. In some examples, identifying the first front corner of the keyboard comprises analyzing the image elements of the image to identify the image element that is (i) part of the object; (ii) below a starting image element 1010 (e.g. towards the user); and (iii) furthest away from the starting image element 1010. The identified image element will be the first front corner of the keyboard.

In some examples the starting image element 1010 is one of the image elements in the slice 1002 that was identified as forming part of the object. For example, the starting image element may be the image element in the centre of the identified object. An image element may be determined to be part of the object if (a) the depth associated with the image element is within the predetermined range; and (b) the image element is contiguous with the other image elements forming the object. Once the first corner 1008 of the object has been identified the method 900 proceeds to block 908.

At block 908, the second front corner 1012 of the keyboard is identified from the depth image 1000. In some examples, identifying the second front 1012 corner of the keyboard comprises analyzing the image elements of the image to identify the image element that is (i) part of the object; and (ii) has the greatest perpendicular distance towards the user from the line 1014 running through the starting point and the first corner 1008. The identified image element will be the second corner of the object. Thus the second corner is identified even if the keyboard is not parallel with the edge of the desktop. Once the second front corner 1012 of the object has been identified the method 900 proceeds to block 910.

At block 910, the front edge of the keyboard is determined to be the line between the first corner 1008 and the second front corner 1012. Once the front edge of the keyboard is determined the area of the image corresponding to the keyboard can be determined. For example, using known keyboard length to depth ratios.

In some examples, the method 900 may be implemented with a color image instead of a depth image. In these examples, instead of analyzing a vertical slice of the image to identify object that has a depth within a predetermined range over a distance within a predetermined range, a vertical slice of the image is analyzed to identify an object that has a color value within a predetermine range over a distance within a predetermined range. The remainder of the method 900 remains the same with the exception that instead of using the depth values associated with each image element (e.g. pixel) to determine whether an image element is part of the object the color values associated with each image element (e.g. pixel) are used to determine whether an image element is part of the object.

Other methods for detecting the location of the keyboard with respect to the desktop or workspace include (a) attaching the capture device 114 to the keyboard 102 and using fixed geometry to determine the location of the keyboard 102; and (b) hard-coding the location of the keyboard 102 into software.

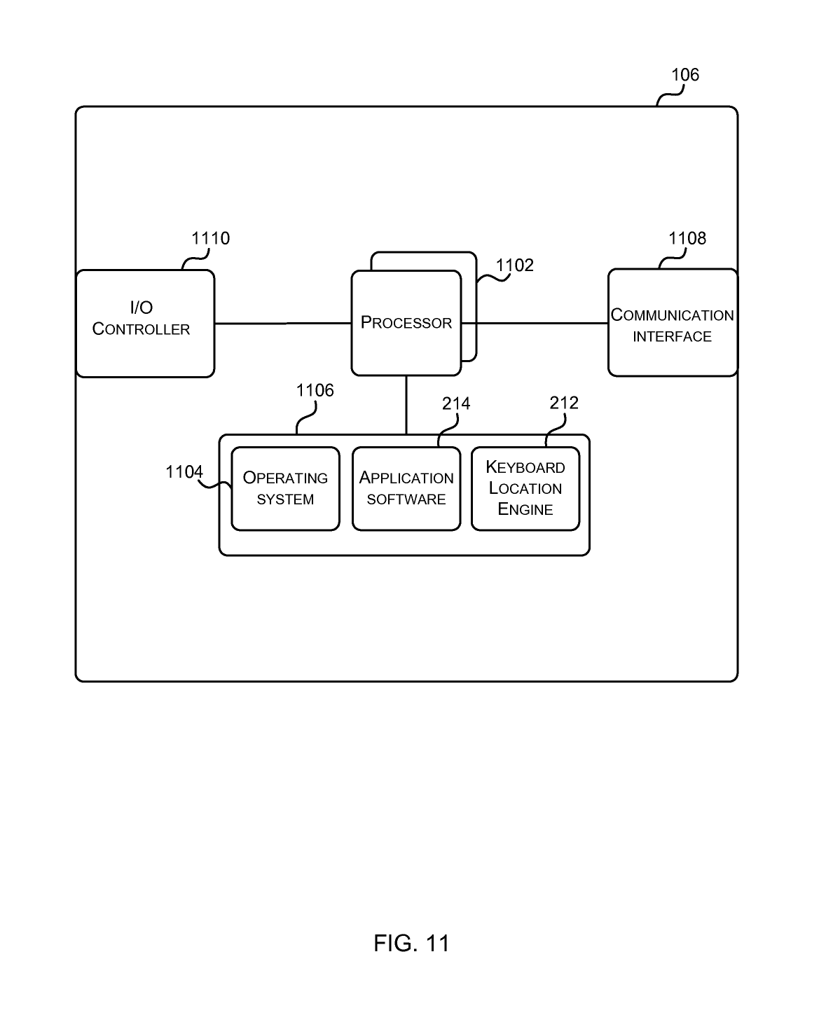

FIG. 11 illustrates various components of an exemplary computing-based device 106 which may be implemented as any form of a computing and/or electronic device, and in which embodiments of the systems and methods described herein may be implemented.

Computing-based device 106 comprises one or more processors 1102 which may be microprocessors, controllers or any other suitable type of processors for processing computer executable instructions to control the operation of the device in order to detect the location of a keyboard with respect to a desktop. In some examples, for example where a system on a chip architecture is used, the processors 1102 may include one or more fixed function blocks (also referred to as accelerators) which implement a part of the method of controlling the computing-based device in hardware (rather than software or firmware). Platform software comprising an operating system 1104 or any other suitable platform software may be provided at the computing-based device to enable application software 214 to be executed on the device.

The computer executable instructions may be provided using any computer-readable media that is accessible by computing based device 106. Computer-readable media may include, for example, computer storage media such as memory 1106 and communications media. Computer storage media, such as memory 1106, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing-based device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 1106) is shown within the computing-based device 106 it will be appreciated that the storage may be distributed or located remotely and accessed via a network or other communication link (e.g. using communication interface 1108).

The computing-based device 106 also comprises an input/output controller 1110 arranged to output display information to a display device 112 (FIG. 1) which may be separate from or integral to the computing-based device 106. The display information may provide a graphical user interface. The input/output controller 1110 is also arranged to receive and process input from one or more devices, such as a user input device 102 (FIG. 1) (e.g. a mouse, keyboard, camera, microphone or other sensor). In some examples the user input device 102 may detect voice input, user gestures or other user actions and may provide a natural user interface (NUI). In an embodiment the display device 112 may also act as the user input device 102 if it is a touch sensitive display device. The input/output controller 1110 may also output data to devices other than the display device, e.g. a locally connected printing device (not shown in FIG. 11).

The input/output controller 1110, display device 112 and optionally the user input device 102 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method of detecting the location of a keyboard on a desktop, the method comprising:
receiving at a computing-based device an image of the desktop with the keyboard situated thereon; and
analyzing the image of the desktop at the computing-based device to determine an area of the image corresponding to the keyboard.

2. The method according to claim 1, wherein the image of the desktop is one of a depth image and a color image and analyzing the image of the desktop to determine the area of the image corresponding to the keyboard comprises:
identifying an image element of the image that forms part of the keyboard;
identifying first and second corners of the keyboard from the identified image element; and
determining the area of the image corresponding to the keyboard based on the first and second corners.

3. The method according to claim 2, wherein:
identifying an image element of the image that forms part of the keyboard comprises analyzing a vertical slice of the depth image to identify an object with a depth within a predetermined range for a distance within a predetermined range; and
the identified image element is a image element in the vertical slice that is part of the identified object.

4. The method according to claim 3, wherein the identified image element is an image element in the vertical slice that depicts a front edge of the object, and identifying the first corner of the keyboard from the identified image element comprises traversing the front edge of the object in a first direction until the first corner is identified.

5. The method according to claim 4, wherein identifying the second corner of the keyboard from the identified image element comprises following the front edge of the object in a second direction until the second corner is identified, the second direction being opposite to the first direction.

6. The method according to claim 3, wherein identifying the first corner of the keyboard from the identified image element comprises identifying the image element in the depth image that is the furthest distance from the identified image element and forms part of the identified object.

7. The method according to claim 6, wherein identifying the second corner of the object from the identified image element comprises identifying the image element in the depth image that has the largest perpendicular distance from a line extending between the first corner and the identified image element and forms part of the identified object.

8. The method according to claim 1, wherein analyzing the image of the desktop to determine the area of the image corresponding to the keyboard comprises:
obtaining a representation of the keyboard; and
performing template matching between the representation of the keyboard and the image of the desktop.

9. The method according to claim 8, wherein obtaining the representation of the keyboard comprises:
obtaining information identifying the shape of the keyboard; and
obtaining the representation of the keyboard from a database of keyboard representations based on the information identifying the shape of the keyboard.

10. The method according to claim 9, wherein the computing-based device comprises a device list listing devices connected to the computing-based device, and the information identifying the shape of the keyboard is obtained from the device list.

11. The method according to claim 9, wherein the information identifying the shape of the keyboard is manually provided to the computing-based device by a user.

12. The method according to claim 1, comprising controlling the display of at least one light source at the keyboard and analyzing the image to determine the area of the image of the desktop corresponding to the keyboard on the basis of the depiction of the light source in the image.

13. The method according to claim 12, wherein the area of the image of the desktop corresponding to the keyboard is determined based on the location of the at least one light source in the image and information identifying the location of the light source with respect to the keyboard.

14. The method according to claim 1, wherein analyzing the image of the desktop to determine the area of the image corresponding to the keyboard comprises:
analyzing the image of the desktop to identify at least two keyboard letters; and
determining the area of the image corresponding to the keyboard based on the at least two identified keyboard letters.

15. The method according to claim 14, wherein analyzing the image of the desktop to identify at least two keyboard letter comprises:
determining at least one of the language and location of the computing-based device; and
determining the layout of the keyboard based on at least one of the language and the location;
wherein the at least two keyboard letters form part of the layout of the keyboard.

16. The method according to claim 15, wherein the area of the image of the desktop corresponding to the keyboard is determined based on the location of the at least one identified keyboard letter and the layout of the keyboard.

17. The method according to claim 1, wherein the method is at least partially carried out using hardware logic.

18. A system to detect the location of a keyboard on a desktop, the system comprising:
a computing-based device configured to:
receive an image of the desktop from a capture device; and
analyze the image of the desktop to determine an area of the image corresponding to the keyboard, on the basis that image elements depicting the keyboard are likely to extend across the centre of the image.

19. The system according to claim 18, the computing-based device being at least partially implemented using hardware logic selected from any one or more of: a field-programmable gate array, a program-specific integrated circuit, a program-specific standard product, a system-on-a-chip, a complex programmable logic device.

20. A method of detecting the location of a keyboard on a desktop, the method comprising:
receiving at a computing-based device a depth image of the desktop with the keyboard situated thereon, the depth image comprising a depth value for each image element of the depth image;
using the depth values to identify an image element of the depth image that forms part of the keyboard;
identifying first and second corners of the keyboard from the identified image element; and
determining the area of the image of the desktop corresponding to the keyboard based on the first and second corners.
